(19) United States
(12) Patent Application Publication
(10) Pub. No.: US 2014/0135121 A1
(43) Pub. Date: May 15, 2014

(54) METHOD AND APPARATUS FOR PROVIDING THREE-DIMENSIONAL CHARACTERS WITH ENHANCED REALITY

(71) Applicant: Samsung Electronics Co., Ltd., Suwon-si (KR)

(72) Inventor: Brhmadesam SATEESH, Noida (IN)

(73) Assignee: Samsung Electronics Co., Ltd., Suwon-si (KR)

(21) Appl. No.: 14/077,301

(22) Filed: Nov. 12, 2013

(30) Foreign Application Priority Data
Nov. 12, 2012 (IN) 4723/CHE/2012
Jul. 24, 2013 (KR) 10-2013-0087608

(51) Int. Cl. A63F 13/30

(52) U.S. Cl. CPC A63F 13/12
USPC 463/31

(57) ABSTRACT

A method of providing through a server a three-dimensional (3D) character on a game to a client in a cloud computing environment is provided. The server receives images from the client that are designated by a user, generates the 3D character by using the received images, and executes a game in which the generated 3D character appears, by interworking with the client. The user may generate a new 3D character by optionally editing a 3D character by a selection based on a menu provided by the server, selecting a style of a new 3D character to be generated, modifying a portion of a body of a current 3D character, or by only using an image designated by the user. Accordingly, it is possible to provide enhanced reality to the user by generating a new 3D character and executing a game in which the new 3D character appears.

### RELATED APPLICATIONS

This application claims priority from India Patent Application No. 4723/CHE/2012, filed on Nov. 12, 2012, in the India Patent Office and Korean Patent Application No. 10-2013-0087608, filed on Jul. 24, 2013, in the Korean Intellectual Property Office, the disclosures of which are incorporated herein by reference, in their entirety.

### BACKGROUND

1. Field

One or more exemplary embodiments relate to methods of providing screen data. More particularly, the exemplary embodiments relate to methods and apparatuses for providing through a server a three-dimensional (3D) character with enhanced reality to a client on a game in a cloud computing environment.

2. Description of the Related Art

Recently, a scheme of playing a game on a terminal according to a server-client model has been widely used. A three-dimensional (3D) scheme is widely used as a character implementing scheme. Generally, in the case of a game in which a 3D character appears, a user plays a game by selecting one of a plurality of predetermined characters. Therefore, the user has the limitation of having to select one of the predetermined characters that are provided in the game.

### SUMMARY

One or more exemplary embodiments includes methods and apparatuses for providing through a server a three-dimensional (3D) character with enhanced reality to a client on a game in a cloud computing environment.

Additional aspects will be set forth in part in the description which follows and, in part, will be apparent from the description, or may be learned by practice of the exemplary embodiments.

According to one or more exemplary embodiments, a method of providing to a client a three-dimensional (3D) character on a game through a server in a cloud computing environment, the method includes: receiving from the client images designated by a user; generating the 3D character by using the received images; and executing a game in which the generated 3D character appears, by interworking with the client.

The generating of the 3D character may include generating a new 3D character by modifying only a portion of a body of a 3D character that is provided in the game.

The method may further include giving the generated 3D character a new attribute based on an external feature of the generated 3D character.

The generating of the 3D character may include providing a menu to edit an external shape of the 3D character, according to a user selection.

The generating of the 3D character may include providing a menu for user selection of one of plural styles.

The generating of the 3D character may include generating the 3D character by using only an image which satisfies a predetermined reference image quality from among the received images.

The executing of the game may include replacing a current character with the generated 3D character.

The executing of the game may include providing a menu for user selection of adding the generated 3D character to a current character and selecting the generated 3D character.

An aspect of the exemplary embodiments may provide a server configured to generate a three-dimensional (3D) character on a game, the server including: a receiver configured to receive images designated by a user; a generator configured to use the received images to generate the 3D character; and an executor configured to execute a game in which the generated 3D character appears.

The server may further include an attributing unit configured to provide the generated 3D character with a new attribute based on an external feature of the generated 3D character.

The images designated by the user may be received from a client. The generator may be configured to provide a menu to edit an external shape of the 3D character according to a user selection.

The executor may be configured to replace a current character with the generated 3D character.

### BRIEF DESCRIPTION OF THE DRAWINGS

These and/or other aspects will become apparent and more readily appreciated from the following description of the exemplary embodiments, taken in conjunction with the accompanying drawings in which:

FIG. 1 is a diagram which illustrates an example in which a server and clients are connected through the Internet, according to an exemplary embodiment;

FIG. 2 is a flowchart of a method for the server to generate a three-dimensional (3D) character and execute a game in which the generated 3D character appears, according to an exemplary embodiment;

FIG. 3 is a flowchart of a method for the server to provide a 3D character with a new attribute and execute a game, according to an exemplary embodiment;

FIG. 4 is a flowchart of a detailed method for the server to generate a 3D character, according to an exemplary embodiment;

FIG. 5 is a flowchart of a method for the server to select a type of game and a game character according to user selection and to execute the selected game, according to an exemplary embodiment;

FIG. 6 is a diagram which illustrates a method for the server to generate a 3D character by modifying a portion of a body of a 3D character, based on a user selection, according to an exemplary embodiment;

FIG. 7 is a diagram which illustrates a method for the server to generate a 3D character by modifying a portion of a body of a 3D character, based on a user selection, according to an exemplary embodiment;

FIG. 8 is a diagram which illustrates a method for the server to generate a 3D character by modifying a portion of a body of a 3D character based on a user selection, according to an exemplary embodiment;

FIG. 9 is a diagram which illustrates a method for the server to edit an external shape of a 3D character based on a user selection, according to an exemplary embodiment;

FIG. 10 is a diagram which illustrates a method for the server to edit an external shape of a 3D character based on a user selection, according to an exemplary embodiment;

FIG. 11 is a diagram which illustrates a method for the server to generate a 3D character based on a user selection of one of different styles, according to an exemplary embodiment;

FIG. 12 is a diagram which illustrates a method for the server to generate a 3D character based on a user selection of one of different styles, according to an exemplary embodiment;

FIG. 13 is a diagram which illustrates a screen for the server to provide the user with a menu for selecting new 3D character generation or one of 3D characters provided by the server, according to an exemplary embodiment;

FIG. 14 is a block diagram which illustrates a configuration of the server, according to an exemplary embodiment; and

FIG. 15 is a block diagram which illustrates a configuration of the client, according to an exemplary embodiment.

### DETAILED DESCRIPTION

Reference will now be made in detail to the exemplary embodiments, examples of which are illustrated in the accompanying drawings, wherein like reference numerals refer to like elements throughout. In this regard, the exemplary embodiments may have different forms and should not be construed as being limited to the descriptions set forth herein. Accordingly, the exemplary embodiments are merely described below, by referring to the figures, to explain aspects of the description. As used herein, the term “and/or” includes any and all combinations of one or more of the associated listed items. Expressions such as “at least one of,” when preceding a list of elements, modify the entire list of elements and do not modify the individual elements of the list.

The following description is made for the purpose of illustrating one or more exemplary embodiments and is not meant to limit the exemplary embodiments described herein. In addition, particular features described herein may be used in combination with other described features in various possible combinations and substitutions. Unless otherwise specifically defined herein, all terms may be given their broadest possible interpretation including meanings implied from the specification as well as meanings understood by those of ordinary skill in the art and/or as defined in dictionaries, treatises, etc.

Exemplary embodiments will be described below in detail with reference to the accompanying drawings so that the exemplary embodiments may be easily implemented by those of ordinary skill in the art. The exemplary embodiments may, however, be embodied in many different forms and should not be construed as being limited to the exemplary embodiments set forth herein. In addition, portions irrelevant to the description of the exemplary embodiments will be omitted in the drawings for a clear description, and like reference numerals will denote like elements throughout the specification.

Although terms such as “first” and “second” may be used herein to describe various elements or components, these elements or components should not be limited by these terms. These terms are only used to distinguish one element or component from another element or component.

As used herein, the singular forms “a”, “an”, and “the” are intended to include the plural forms as well, unless the context clearly indicates otherwise.

Hereinafter, exemplary embodiments will be described in detail with reference to the accompanying drawings. In the following description, like reference numerals denote like elements, and a redundant description thereof may be omitted.

For a clear understanding of the exemplary embodiments, a description of well-known technology relevant to disclosed features will be omitted. The following exemplary embodiments are provided for a better understanding and are not intended to limit the scope of the invention. Therefore, equivalent concepts performing the same function as the exemplary embodiments will also be included within the scope of the description. In the following description, like reference symbols denotes like elements, and a redundant description and a description of well-known technology will be omitted.

As used herein, the terms “communication,” “communication network,” and “network” may have the same meaning. These three terms may refer to wired/wireless near field communication networks and broadband data communication networks that may communicate files between a user terminal, another user terminal and a download server.

The term “cloud” may refer to an infrastructure hidden in a network.

The term “server 140” may refer to a cloud server. The cloud server may be a server that performs cloud computing.

Also, the term “clients 110 to 130” may refer to smartphones, mobile phones, personal digital assistants (PDA), laptop computers, media players, Global Positioning System (GPS) apparatuses, and other mobile or non-mobile computing apparatuses, but are not limited thereto and may include any other devices providing a display screen.

Also, the term “computer-readable recording medium” may refer to any medium that participates in providing data for causing an apparatus to perform a particular function. Various non-transitory computer-readable recording media may be used in an exemplary embodiment of implementing the server 140. The computer-readable recording media include volatile recording media and nonvolatile recording media. Examples of the recording media may include floppy disks, magnetic tapes, hard disks, other types of magnetic media, CD-ROMs, optical storages, PROMs, EPROMs, and memory chips. The recording media may be configured to physically search for commands transmitted by media.

In another exemplary embodiment, the computer-readable recording media may be transmission media including a bus. The transmission media may include coaxial cables, copper wires, and optical fibers. The transmission media may be media that are used in communications including radio-wave or infrared communications.

The exemplary embodiments may provide enhanced reality. The enhanced reality may be provided by displaying physical real-world environments in real time. The reality may be enhanced by sensible inputs, such as, sound, video, graphics, and GPS data, that are generated by computers. The reality may be improved by improving human sense-related technology. The server 140 may provide virtual information to provide realistic sensible information, thereby providing the enhanced reality so that users may sense the virtual information as real information.

A realistic scene provided by the server 140 may be characterized in that a three-dimensional (3D) character and a real word environment are combined with each other, a 3D character is interactively controlled by a user, and the realistic scene is a 3D image.

Hereinafter, exemplary embodiments will be described in detail with reference to the accompanying drawings.

FIG. 1 is a diagram which illustrates an example in which a server 140 and clients 110 to 130 are connected through the Internet 150, according to an exemplary embodiment.

The server 140 may be connected to one or more clients 110 to 130 through the Internet 150. The server 140 may be a server that performs cloud computing. Cloud computing may be a computing environment in which IT-related services, such as a data storage service, a network service and a content use service, may be simultaneously used through servers on the Internet.

The computing environment may include a plurality of clients, for example, clients 110 to 130. Also, the computing environment may include the server 140 connected on a network. Examples of the clients 110 to 130 may include computers, laptop computers, mobile phones, portable PDAs, and remote communication devices. Examples of the network may include local area networks (LANs), wide area networks (WANs), and wireless networks. However, exemplary embodiments are not limited thereto.

The clients 110 to 130 may be connected to the server 140 through the Internet 150. Also, the clients 110 to 130 may receive 3D characters generated by the server 140 through the Internet 150. The Internet 150 may be a cloud network.

Also, the server 140 and the clients 110 to 130 may execute a game by interworking with each other.

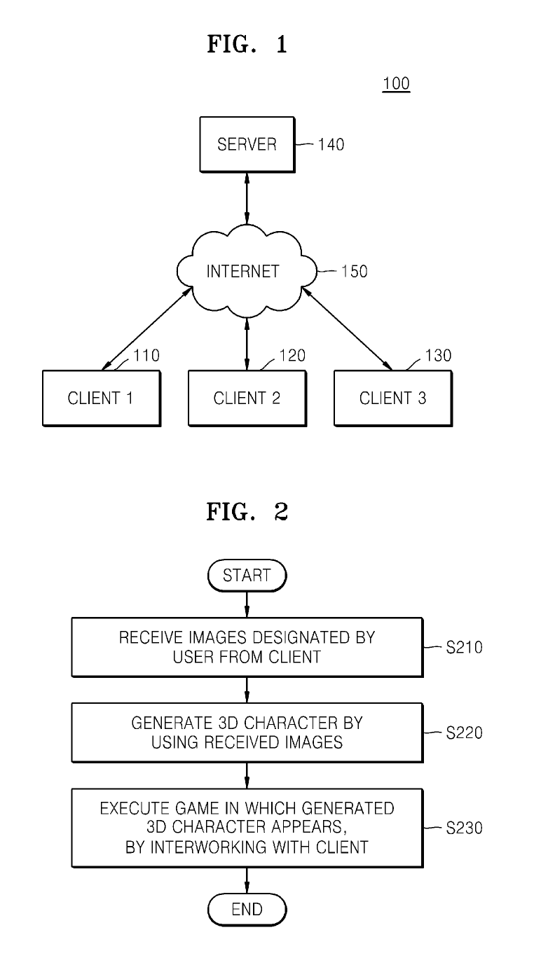

FIG. 2 is a flowchart of a method for the server 140 to generate a 3D character and execute a game in which the generated 3D character appears, according to an exemplary embodiment.

In operation S210, the server 140 may receive images from a client that are designated by the user. The images designated by the user may be images that are obtained by photographing an object at various angles. The images designated by the user may be images that are obtained by photographing the user with a two-dimensional (2D) camera. The images designated by the user may be obtained by capturing.

In operation S220, the server 140 may generate a 3D character by using the images received in operation S210.

The images received by the server 140 may be the images designated by the user. Therefore, the received images may not necessarily be images of the user. For example, the received images may be pictures of entertainers or pictures of erasers. When a picture of an entertainer is received, the 3D character may be based on an external shape of the entertainer. When a picture of an eraser is received, the 3D character may be based on an external shape of the eraser. For example, the server 140 may generate a 3D character having a head shaped like an eraser.

Image processing technology may be applied to the operation of generating the 3D character by the server 140. An image of the generated 3D character may be displayed to the user. When a new 3D character is generated, the server 140 may provide a menu which allows the user to replace a current character with the generated 3D character or add the generated 3D character to a current character.

Examples of the image processing technology may include image registration and image segmentation. A plane coordinate system may be transformed into a 3D coordinate system by calculating parameters related to one or more images. In the image processing operation, images may overlap each other.

The server 140 may convert 2D data into a 3D data model by using an image set which includes images.

The image set including images may be acquired by a 2D camera, or may be acquired by photographing images in various directions.

An image processing method may use a method of converting a 2D image into 3D data.

In operation S230, the server 140 may execute a game in which the 3D character generated in operation S220 appears, by interworking with the client.

The game may be executed in the server 140 and/or in clients 110 to 130. The server 140 may execute the game by interworking with the clients 110 to 130. That is, the server 140 may generate a 3D character, and the clients 110 to 130 may display a game in which the 3D character appears.

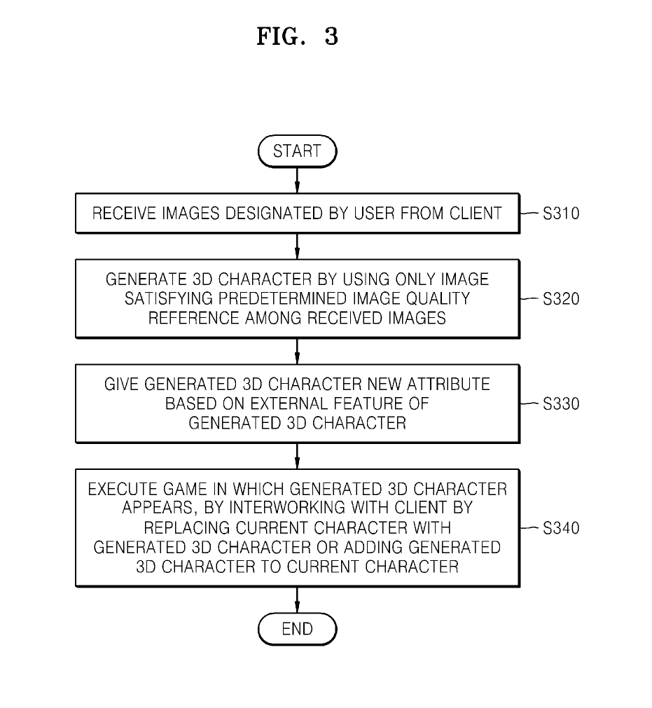

FIG. 3 is a flowchart of a method for the server 140 to provide a 3D character with a new attribute and execute a game, according to an exemplary embodiment.

In operation S310, the server 140 may receive images designated by the user from the client, which may be similar to operation S210 of FIG. 2.

In operation S320, the server 140 may generate a 3D character by only using an image which satisfies a predetermined reference image quality from among the images received in operation S310. In operation S320, an image failing to satisfy the predetermined reference image quality may be excluded in generating the 3D character. When an image of an excessively low image quality is used in generating a 3D character, a 3D character having an external shape which does not match the user's intent may be generated. Therefore, in operation S320, the 3D character may be generated by using only an image which satisfies the predetermined reference image quality.

In operation S330, the server 140 may provide the generated 3D character with a new attribute based on an external feature of the 3D character generated in operation S320. For example, when an arm of the 3D character generated in operation S320 is abnormally thick, a power level related to the arm of the 3D character may be set to be high in the game. Also, when a leg of the 3D character generated in operation S320 is abnormally long, a power level related to the legs of the 3D character may be set to be high in the game.

In operation S340, the server 140 may execute a game in which a 3D character generated by replacing a current character with the 3D character generated in operation S220 or adding the generated 3D character to a current character appears, by interworking with the client. One of the current characters may be removed from an available character list, and the 3D character generated in operation S310 may be added thereto. Alternatively, all the current characters may remain in an available character list, and the 3D character generated in operation S310 may be added thereto.

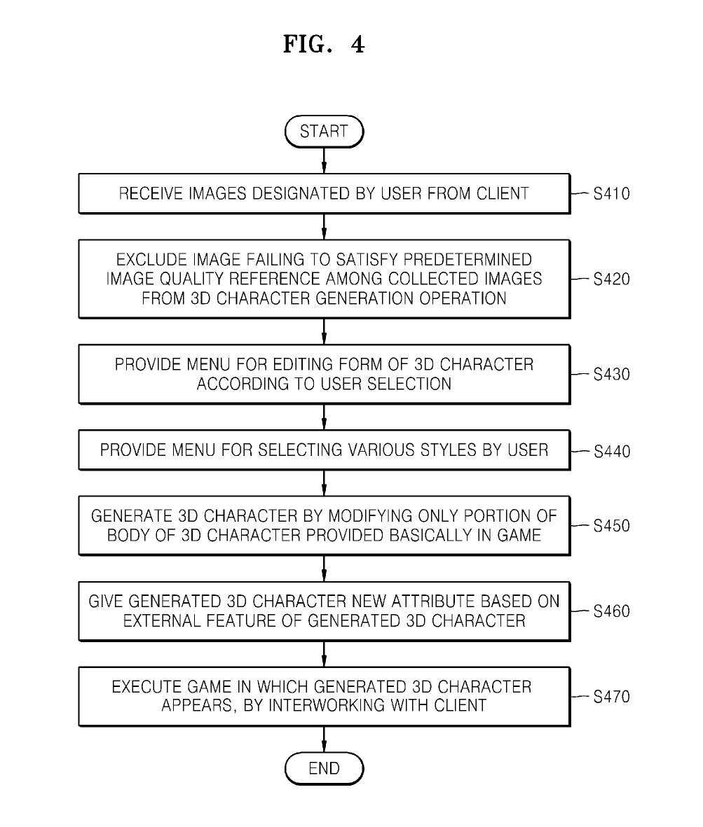

FIG. 4 is a flowchart of a detailed method for the server 140 to generate a 3D character, according to an exemplary embodiment.

In operation S410, the server 140 may receive images designated by the user from the clients 110 to 130. Operation S410 may be similar to operation S210 of FIG. 2.

In operation S420, the server 140 may exclude a 3D character which fails to satisfy a predetermined reference image quality from among collected images from the 3D character generation operation. That is, operation S420 may be similar to operation S320 of FIG. 3.

In operation S430, the server 140 may provide a menu for editing an external shape or form of a 3D character, according to a user selection.

In operation S430, a menu for the user optionally editing a form of a 3D character by may be provided. For example, the user may control a head size of the 3D character.

The user may control a leg length of the 3D character. Also, the user may control an arm length of the 3D character. The user may control an arm thickness of the 3D character. The server 140 may provide a menu for editing a form of a 3D character.

The menu for editing a form of a 3D character may include a menu for editing a color of a portion or all of a body or costume of a 3D character.

The menu for editing a form of a 3D character may include a menu for editing a size of a portion or all of a body or costume of a 3D character.

In operation S440, the server 140 may provide a menu for the user to select various styles. Unlike in operation S430, in operation S440, the server 140 may provide a menu for selecting one of predetermined styles in order to edit a 3D character.

For example, when the user selects a “like boxer” option, the server 140 may generate a 3D character that has a short hairstyle and a muscular body while maintaining the basic features of an original 3D character. When the user selects a “like angel” option, the server 140 may generate a 3D character that has big eyes, fair skin, and wings on the back while maintaining the basic features of an original 3D character.

A plurality of styles may be predetermined, and the user may select an additional feature of the 3D character simply by selecting one of the styles. However, only a style of the 3D character may be modified, and the basic features of the original 3D character may be maintained.

In operation S450, the server 140 may generate a 3D character by only modifying a portion of a body of a basic 3D character provided in the game. For example, when there is a basic 3D character provided in the game, only a head shape may be modified into a head shape based on the image designated by the user. When an image provided by the user is an eraser image and a body region of a 3D character to be edited by the user is a head, the server 140 may provide a 3D character that is obtained by modifying a head shape of a basic 3D character into an eraser shape. Alternatively, the server 140 may generate a 3D character by modifying legs, arms, or a body instead of or in addition to a head.

In operation S460, the server 140 may provide the generated 3D character with a new attribute based on an external feature of the generated 3D character. Operation S460 may be similar to operation S330 of FIG. 3.

In operation S470, the server 140 may execute a game in which the generated 3D character appears, by interworking with the client. Operation S470 may be similar to operation S230 of FIG. 2.

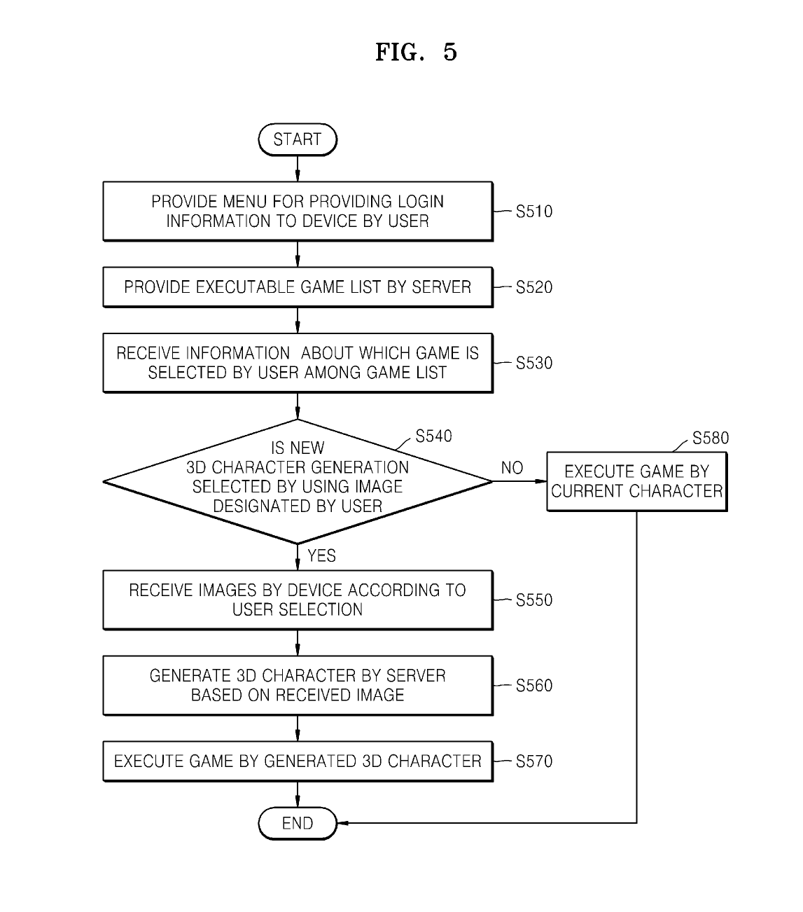

FIG. 5 is a flowchart of a method for the server 140 to select a game type and a game character according to a user selection and to execute a game, according to an exemplary embodiment.

In operation S510, the server 140 may provide a menu allowing the user to provide login information to a device. The user may log in by inputting login information according to the menu provided in operation S510. The server 140 may provide a menu for providing relevant information based on the login information input by the user.

In operation S520, the server 140 may provide an available game list to the user based on the login information of the user that is received in operation S510. a user. Alternatively, the server 140 may provide an accessible game list to the logged-in user. A game list to be provided to the user providing the login information may be predetermined in the server 140.

In operation S530, the server 140 may receive information related to which game the user has selected from the game list provided in operation S520 by the server 140. Then, the server 140 may execute a game selected by the user.

While executing a game, the server 140 may provide a menu which allows the user to select from a 3D character list included in the game. In particular, the server 140 may provide a menu which allows the user to select a desired 3D character from the 3D character list included in the game.

The user may select a desired 3D character from the 3D character list provided by the server 140. Alternatively, the user may select a new character generation instead of selecting a 3D character from the 3D character list provided by the server 140.

In operation S540, the server 140 may determine whether the user selects new 3D character generation. When the user selects new 3D character generation, the server 140 may proceed to operation S550; and when the user does not select new 3D character generation, the server 140 may proceed to operation S580.

In operations S550, S560 and S570, the server 140 may operate in the same manner as described with reference to FIG. 2.

In operation S580, the server 140 may execute a game with the current 3D character and not a new 3D character.

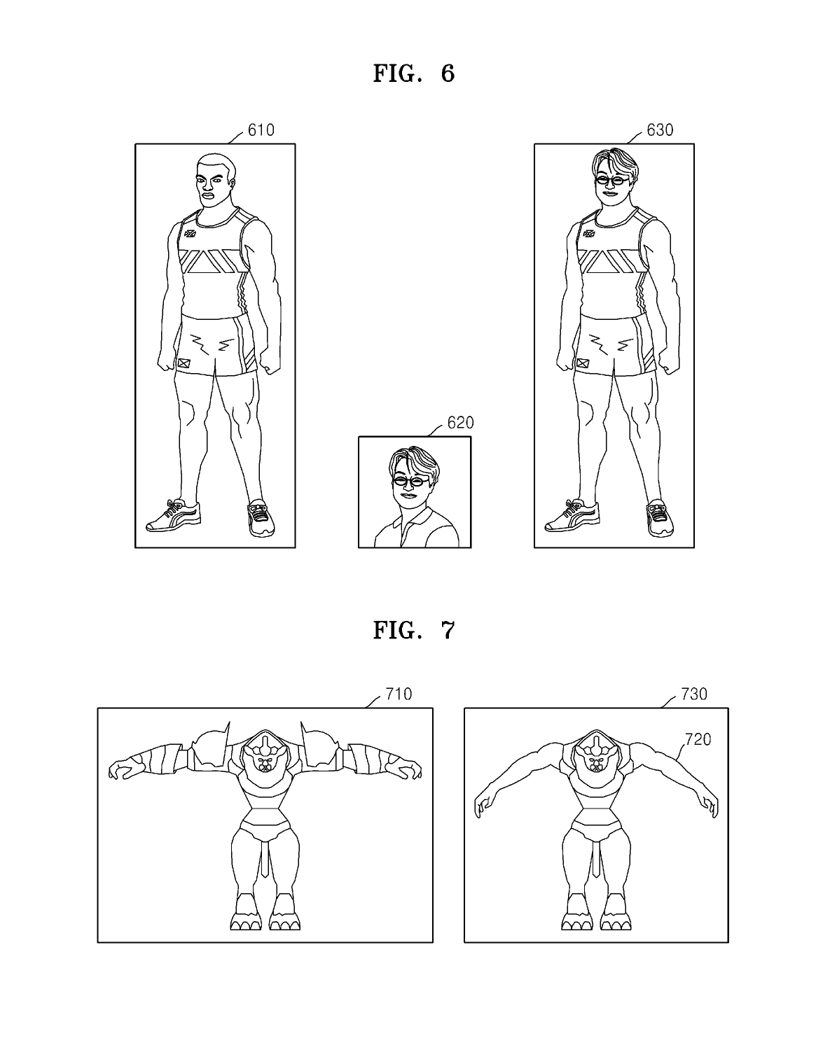

FIG. 6 is a diagram which illustrates a method for the server 140 to generate a 3D character by modifying a portion of a body of a 3D character based on user selection, according to an exemplary embodiment.

The user may select new character generation by modifying a portion of a body of a current 3D character 610 provided by the server 140. For example, the user may select modification of only a head portion of the current 3D character 610. Also, the user may provide an image in order to modify a portion of the body of the current 3D character 610. In particular, an image 620 designated by the user may be an image of a head portion. Also, the image 620 designated by the user may or may not be an image of the user. For example, the image 620 designated by the user may be a face image of the user, or the image may be an image of an entertainer. Alternatively, the image 620 designated by the user may be an image of an object such as an eraser.

The user may select the current 3D character 610 to be modified, and may select a body region to be modified. The server 140 may receive the image 620 designated by the user. The server 140 may generate a new 3D character 630 based on the image 620 designated by the user. The new 3D character 630 may be generated by modifying a portion of the body of the current 3D character 610 into the image 620 designated by the user. However, the exemplary embodiment illustrated in FIG. 6 is merely exemplary, and the server 140 may generate a 3D character by receiving a plurality of images designated by the user. A character shape, which may not be checked at angles which correspond to the images designated by the user, may be determined by the server 140 according to a predetermined method. Alternatively, the server 140 may generate a 3D character by using a shape that is most similar from among the images stored in the server 140.

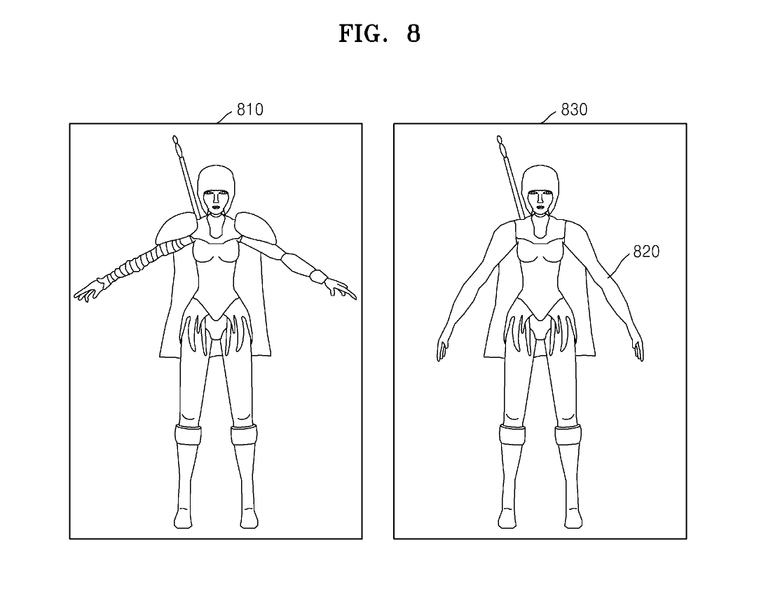

FIG. 7 is a diagram illustrating a method for the server 140 to generate a 3D character by modifying a portion of a body of a 3D character based on user selection, according to an exemplary embodiment.

Unlike FIG. 6, FIG. 7 illustrates an exemplary embodiment in which the server 140 modifies an arm portion of a 3D character. The server 140 may modify an arm portion of a current 3D character 710 by using an image 720 designated by the user. A detailed modification method may be similar to that in FIG. 6.

FIG. 8 is a diagram which illustrates a method for the server 140 to generate a 3D character by modifying a portion of a body of a 3D character based on user selection, according to an exemplary embodiment.

Unlike FIG. 6, FIG. 8 illustrates an exemplary embodiment in which the server 140 modifies an arm portion of a 3D character. The server 140 may modify an arm portion of a current 3D character 810 by using an image 820 designated by the user. A detailed modification method may be similar to that described in FIG. 6.

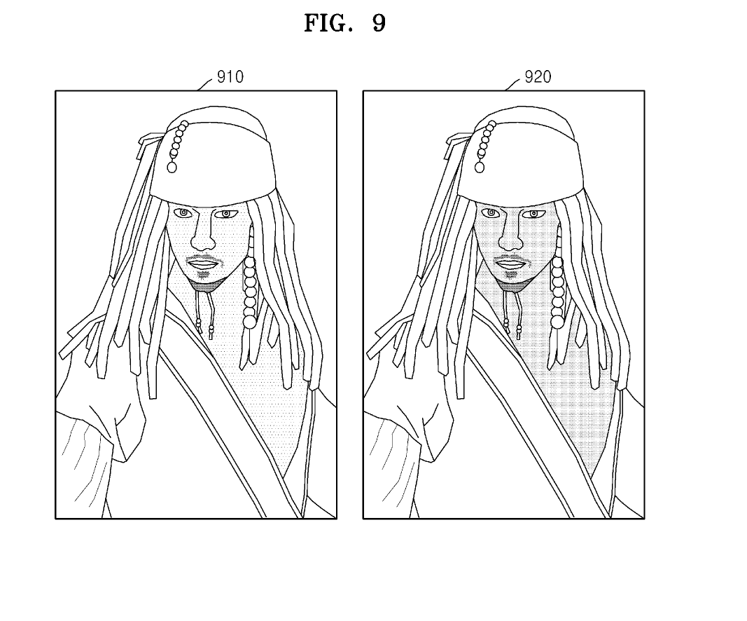

FIG. 9 is a diagram which illustrates a method for the server 140 to edit an external shape of a 3D character based on a user selection, according to an exemplary embodiment.

A skin color of a 3D character 910 may be bright prior to editing. However, the server 140 may modify the skin color of the 3D character 910 based on a user selection. The user may select an option of darkening the skin color of the 3D character 910 through an edit menu. When the user selects the option of darkening the skin color of the 3D character 910 through the edit menu, a 3D character 920 with a darkened skin color may be generated. The server 140 may provide a menu for editing a skin brightness level of a 3D character. In addition, the server 140 may provide a menu for selecting a skin color of a 3D character.

The user may optionally edit the 3D character 910 according to the menu provided by the server 140.

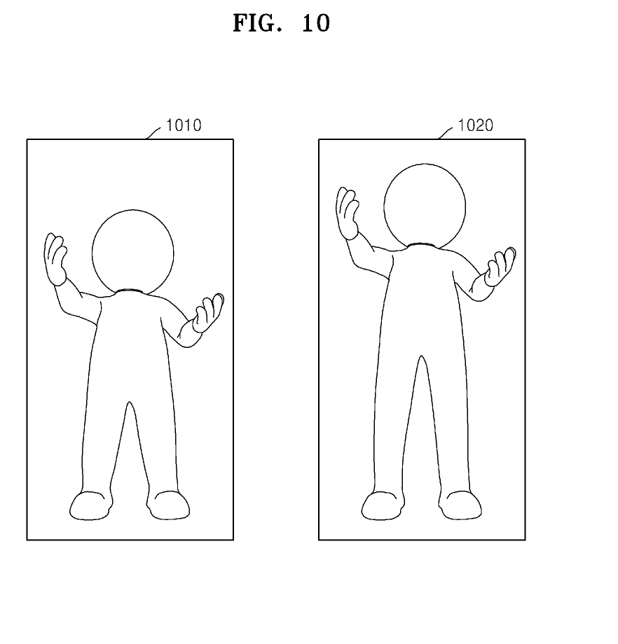

FIG. 10 is a diagram a method for the server 140 to edit an external shape of a 3D character based on a user selection, according to an exemplary embodiment.

Legs of a 3D character 1010 prior to editing may be short. However, the user may modify a leg length of the 3D character according to a selection in the edit menu. Therefore, when the user selects a menu for lengthening the legs of the 3D character through the edit menu, the server 140 may generate a 3D character 1020 with lengthened legs. In the process of lengthening the legs of the 3D character, the server 140 may provide a menu for selecting a leg length degree of the 3D character. A maximum value and a minimum value of the leg length of the 3D character may be predetermined. Also, the server 140 may edit a leg thickness of the 3D character according to a user selection. The user may optionally edit the 3D character according to the menu provided by the server 140, and the server 140 may generate a new 3D character based on the user selection.

The exemplary embodiments illustrated in FIGS. 9 and 10 are merely exemplary, and various features other than the skin color and the leg length may be edited. Also, these edits may be performed by the server 140 providing an edit menu. A particular style is not predetermined, and the 3D character may be optionally edited according to a user selection.

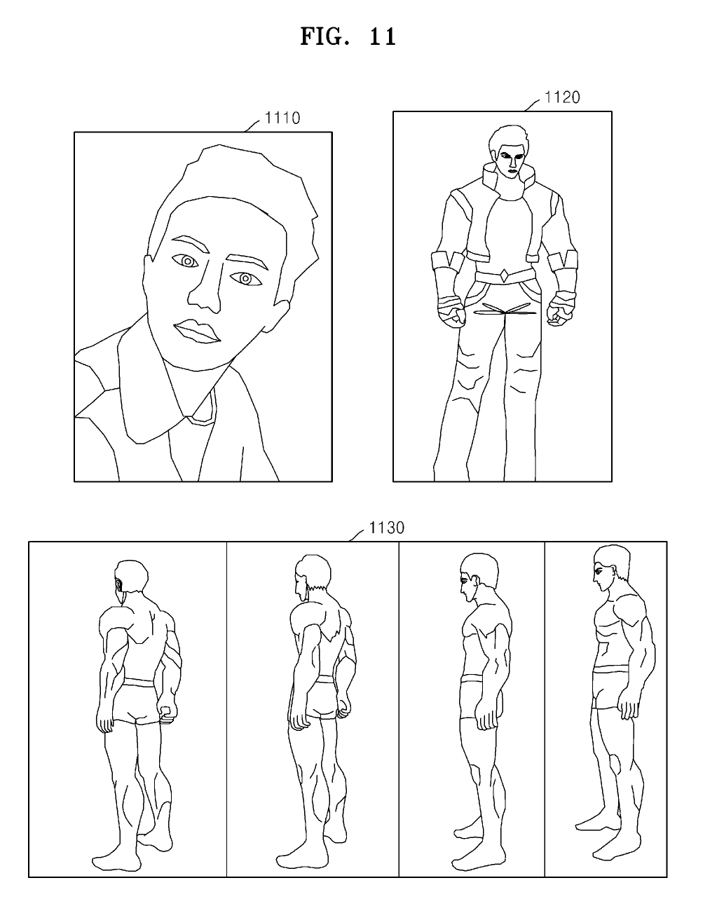

FIG. 11 is a diagram which illustrates a method for the server 140 to generate a 3D character based on a user selection of one of predetermined styles, according to an exemplary embodiment.

An image 1110 designated by the user may be an image of a certain portion of a body. A portion, which may not be checked via the image 1110 designated by the user, may be determined by the server 140 according to a predetermined method. For example, only when an external shape of a face in the image 1110 designated by the user may be checked, the external shapes of a body, arms, and legs of a 3D character may be generated by the server 140, based on an image prestored in the server 140.

The server 140 may provide a menu which allows the user to select one of the predetermined styles. Also, the server 140 may generate a 3D character based on the style selected by the user.

For example, the server 140 may provide a “like boxer” option to the user. When the user selects the “like boxer” option, the server 140 may generate a 3D character which reflects the selected option in the image 1110 designated by the user. The server 140 may generate new 3D characters 1120 and 1130 that have a boxer image that is similar to the image 1110 designated by the user. Also, the server 140 may generate both the new 3D character 1120 wearing a costume, and the new 3D character 1130 not wearing a costume.

When the user selects the “like boxer” option, the server 140 may generate a new 3D character having a muscular body. Also, the server 140 may generate a new 3D character that has a face with rising eyes and thick eyebrows.

However, this is merely exemplary, and modification methods which correspond to respective styles may be predetermined differently, according to the characteristics of games.

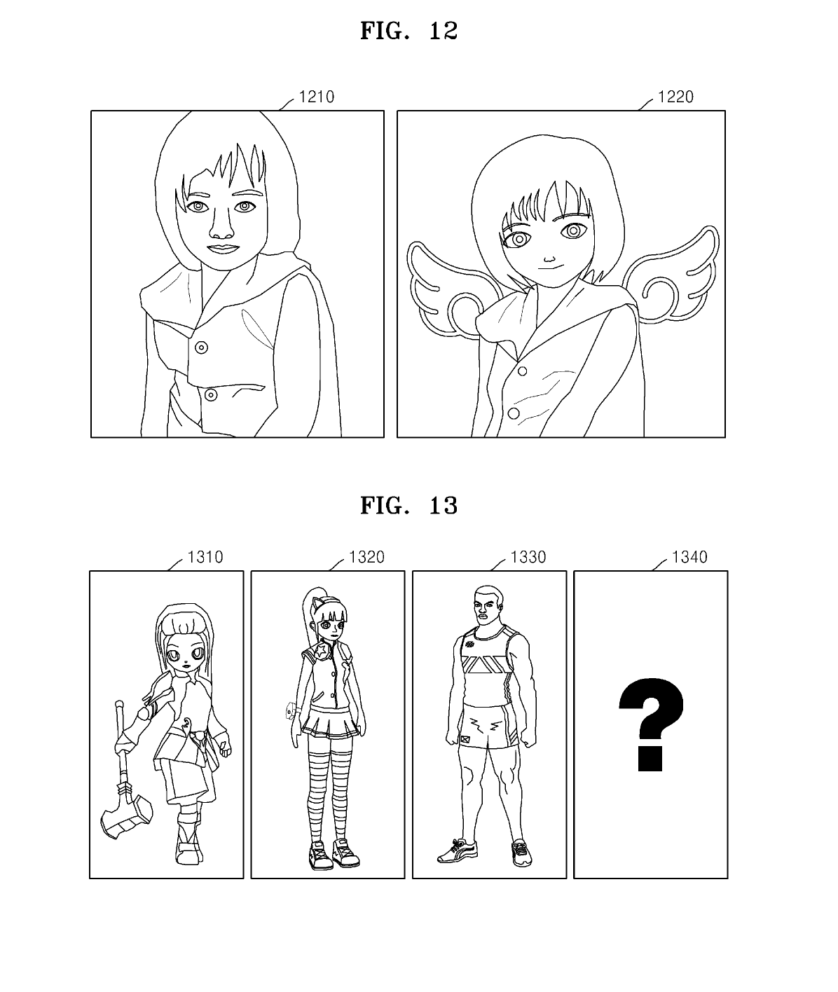

FIG. 12 is a diagram which illustrates a method for the server 140 to generate a 3D character based on user selection of one of predetermined styles, according to an exemplary embodiment.

An image 1210 designated by the user may be an image of a certain portion of a body. A portion, which may not be checked via the image 1210 designated by the user, may be determined by the server 140 according to a predetermined method. For example, when only the external shapes of a face and a body in the image 1210 designated by the user may be checked, the external shapes of arms and legs of a 3D character may be generated by the server 140, based on a prestored image in the server 140.

The server 140 may provide a menu allowing the user to select one of predetermined styles. Also, the server 140 may generate a 3D character based on the style selected by the user.

For example, the server 140 may provide a “like angel” option to the user. When the user selects the “like angel” option, the server 140 may generate a 3D character which reflects the selected option in the image 1210 designated by the user. The server 140 may generate a new 3D character 1220 that has an angel image that is similar to the image 1210 designated by the user.

When the user selects the “like angel” option, the server 140 may generate a 3D character that has bigger eyes, slim arms and legs, fair skin, and wings on the back.

However, this is merely exemplary, and modification methods which correspond to respective styles may be predetermined differently, according to the characteristics of games.

FIG. 13 is a diagram which illustrates a screen for the server 140 to provide the user with a menu for selecting new 3D character generation or one of 3D characters provided by the server 140, according to an exemplary embodiment.

When the user selects current 3D characters 1310 to 1330 provided by the server 140, the server 140 may execute a game with the selected current 3D characters 1310 to 1330. However, the user may select a block 1340 for new 3D character generation in order to generate a new 3D character. When the user selects the block 1340 for new 3D character generation, the server 140 may provide a menu for various selection options. The server 140 may also generate a new 3D character according to a user selection. Also, the server 140 may provide an edit-related menu in the process of generating the new 3D character.

A menu different from the menu provided on the present screen may be provided. In particular, the server 140 may replace a current 3D character with the generated 3D character. When the server 140 replaces a current 3D character with the generated 3D character, the user may no longer select the current 3D character.

Alternatively, the server 140 may display the current 3D character and the generated 3D character together. The server 140 may add the generated 3D character to a character selection list according to a user selection, and the current 3D character may be set to not disappear from the character selection list.

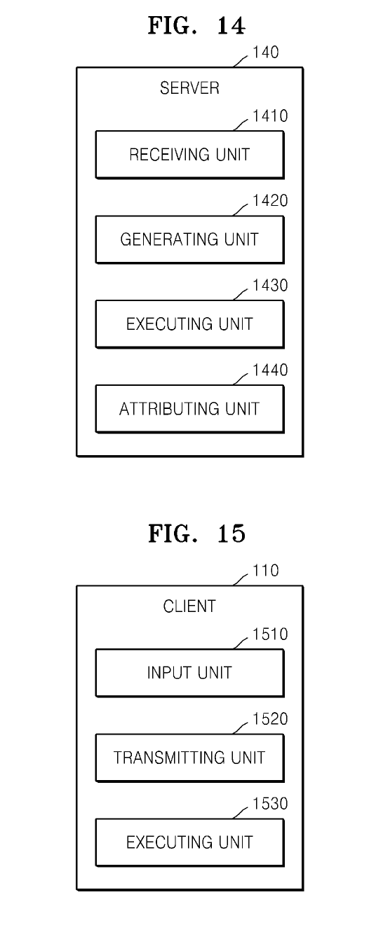

FIG. 14 is a block diagram which illustrates a configuration of the server 140 according to an exemplary embodiment. The server 140 may include a receiver 1410, a generator 1420, an executor 1430, and an attributing unit 1440.

The receiver 1410 may receive from clients 110 to 130 images designated by the user. Also, the receiver 1410 may receive data related to game execution from clients 110 to 130. The data may be received through the Internet.

The generator 1420 may generate a 3D character by using the images received by the receiver 1410. The generated 3D character may not necessarily have the same form as the received image. However, the generated 3D character may be generated based on the received image.

When the generator 1420 generates a 3D character, the server 140 may provide the user with an edit menu which allows the user to optionally edit a 3D character, and may provide the user with a menu which allows the user to select one of predetermined styles.

Alternatively, the generator 1420 may generate a new 3D character by modifying a portion of a body of a current 3D character. A body region to be modified may be selected by the user, and a shape to be modified into may be determined by an image designated by the user.

The executor 11430 may execute a game in which the 3D character generated by the generator 1420 appears, by interworking with the clients 110 to 130.

The executor 1430 may provide game-related data to the clients 110 to 130, and the clients 110 to 130 may execute a game based on the data received from the executor 1430. Also, the clients 110 to 130 may display a game screen.

The attributing unit 1440 may provide the generated 3D character with a new attribute based on a feature of the generated 3D character generated by the generator 1420. In particular, the attributing unit 1440 may provide the generated 3D character with a new attribute based on an external feature of the generated 3D character generated by the generator 1420. For example, when an arm of the 3D character generated by the generator 1420 is abnormally thick, a power level related to the arm of the 3D character may be set to be high in the game. When a leg of the 3D character generated by the generator 1420 is abnormally long, a running power level related to the legs of the 3D character may be set to be high in the game.

In addition, the server 140 may perform all of the above-described methods in addition to the operations described with reference to FIG. 14.

FIG. 15 is a block diagram which illustrates a configuration of the client 110, 120 or 130 according to an exemplary embodiment. The clients 110 and 130 may include user input 1510, a transmitter 1520, and, an executor 1530.

Also, the clients 110 and 130 may receive a 3D character on a game from the server 140 in a cloud computing environment. The clients 110 to 130 may be connected to the server 140 through the Internet 150. The 3D character received by the clients 110 to 130 may be generated by the server 140.

The user input 1510 may receive a user input for designating images. The user may designate images for 3D character generation from among the images stored in a client, by an input through the user input 1510. Alternatively, the user may designate images for 3D character generation from among the images input through an input device such as a camera, by an input through the user input 1510.

The transmitter 1520 may transmit to the server 140 images designated by a user input for designating images for 3D character generation. The designated images may be transmitted through the Internet 150.

The executor 11430 may interwork with server 140 to execute a game in which the 3D character generated by the server 140 appears.

In addition, the exemplary embodiments are not limited to 3D characters, and may also be similarly applied to 2D characters. However, the user may not designate a plurality of images so that the exemplary embodiments may be applied to 2D characters.

Also, the server may include a bus or a communicator for information communication. In addition, the server may include a memory such as RAM or a dynamic storage that is connected to the bus to store processed commands and information. The memory may be used to store temporary variables or other intermediate information while a command is executed by the server. Also, the server may include ROM or any other storage that is connected to the bus to store commands for game execution. A storage device, such as a magnetic disk or an optical disk, may be connected to the bus to store information.

The exemplary embodiments may be implemented by executing commands included in the memory. The commands for game execution may be read into the memory from a computer-readable recording medium.

As used herein, the term “computer-readable recording medium” may refer to any medium that participates in providing data for causing the apparatus to perform a particular function. The computer-readable recording medium may be configured to physically search for commands in the apparatus.

The screen data providing methods and apparatuses according to the exemplary embodiments described above may be executed in a virtual desktop infrastructure (VDI) environment or in a cloud computing environment. A program for the screen data providing methods may be recorded in the computer-readable recording medium.

The program may be recorded in a non-transitory computer-readable recording medium and may be executed by a computer to perform the above-described functions.

In order to implement the screen data providing methods and apparatuses according to the exemplary embodiments, the above-described program may include codes that are encoded by computer languages, such as C, C++, JAVA, and machine languages, that are readable by a processor (CPU) of a computer.

The codes may include a function code that is related to a function defining the above-described functions, and may include an execution process-related control code that is necessary for the processor of the computer to perform the above-described functions, according to a predetermined process.

The codes may further include additional information that is necessary for the processor of the computer to perform the above-described operations, and a memory reference-related code that indicates information related to which location (address) in an internal or external memory of the computer the media are to be referred to.

When the processor of the computer needs to communicate with any remote computer or server in order to perform the above-described functions, the codes may further include a communication-related code that indicates information related to the way how the processor of the computer should communicate with any remote computer or server by using a communication module (for example, wired and/or wireless communication modules) of the computer, and information related to which information or media the processor of the computer should communicate with.

Functional programs, codes, and code segments for implementing the exemplary embodiments may be easily construed or modified by programmers skilled in the art to which the exemplary embodiments pertain, in consideration of a system environment of the computer that reads a recording medium to execute a program.

Examples of the computer-readable recording medium storing the program may include read-only memory (ROM), random-access memory (RAM), a CD-ROM, a magnetic tape, a floppy disk and optical media storage.

Also, the computer-readable recording medium storing the program may be distributed over network-coupled computer systems so that a computer-readable code may be stored and executed in a distributed fashion. In this case, at least one of plural distributed computers may execute some of the above-described functions and transmit the execution result to at least one of other distributed computers. The computer receiving the execution result may also execute some of the above-described functions and transmit the execution result to other distributed computers.

In particular, the computer-readable recording medium, which stores an application that is the program for implementing the screen data providing methods and apparatuses according to the exemplary embodiments, may be a storage medium (for example, a hard disk) included in an application provider server, such as an application store server or a Web server related to an application or a relevant service, or may be the application provider server.

The computer, which may read the recording medium storing an application that is the program for implementing the 3D character providing methods and apparatuses according to the exemplary embodiments, may include a general PC, such as a desktop computer or a notebook computer, and a mobile terminal, such as a smartphone, a tablet PC, a PDA, or a mobile communication terminal, and may be any computing device.

When the computer, which may read the recording medium storing an application that is the program for implementing the screen data providing methods and apparatuses according to the exemplary embodiments, is a mobile terminal, such as a smartphone, a tablet PC, a PDA, or a mobile communication terminal, the application may be downloaded from the application provider server to the general PC and installed in the mobile terminal through a synchronization program.

Although all of the components of the exemplary embodiments have been described above as being assembled or operatively connected as one unit, the exemplary embodiments are not limited thereto. That is, within the scope of the exemplary embodiments, the respective components may be selectively and operatively combined into at least one unit. Every one of the components may also be implemented by independent hardware, while the respective ones may be combined in part or as a whole selectively and implemented in a computer program having program modules for executing some or all of functions of the hardware equivalents. Codes or code segments constituting the computer program may be easily deduced by those of ordinary skill in the art. The computer program may be stored in storage media (computer-readable media), and may be read and executed by the computer to implement the embodiments of the present invention. The computer-readable media may include magnetic recording media and optical recording media.

Also, terms such as “include,” “comprise,” and “have” should be interpreted in default as inclusive or open rather than exclusive or closed unless expressly defined to the contrary. Unless otherwise defined, all terms, including technical and scientific terms, have the same meaning as commonly understood by those of ordinary skill in the art. Common terms, such as those defined in commonly used dictionaries, should be interpreted as having the meaning that is consistent with their meaning in the context of the relevant art and will not be interpreted in an idealized or overly formal sense unless expressly so defined herein.

It should be understood that the exemplary embodiments described herein should be considered in a descriptive sense only and not for purposes of limitation. Descriptions of features or aspects within each embodiment should typically be considered as available for other similar features or aspects in other exemplary embodiments.

While one or more exemplary embodiments have been described with reference to the figures, it will be understood by those of ordinary skill in the art that various changes in form and details may be made therein without departing from the spirit and scope of the exemplary embodiments as defined by the following claims. The exemplary embodiments should be considered in a descriptive sense only and not for purposes of limitation. Therefore, the scope of the present invention is defined not by the detailed description of the exemplary embodiments but by the appended claims, and all differences within the scope will be construed as being included in the scope of the present invention.

What is claimed is:

1. A method of providing to a client a three-dimensional (3D) character on a game through a server in a cloud computing environment, the method comprising:
receiving from the client images designated by a user;
generating the 3D character by using the received images; and
interworking with the client to execute a game in which the generated 3D character appears.

2. The method of claim 1, wherein the generating of the 3D character comprises generating a new 3D character by modifying only a portion of a body of a 3D character that is provided in the game.

3. The method of claim 1, further comprising giving the generated 3D character a new attribute based on an external feature of the generated 3D character.

4. The method of claim 1, wherein the generating of the 3D character comprises providing a menu to edit an external shape of the 3D character, according to a user selection.

5. The method of claim 4, wherein the menu for editing the external shape of the 3D character comprises a menu to edit a color or size of a portion or all of a body or costume of the 3D character.

6. The method of claim 1, wherein the generating of the 3D character comprises providing a menu to select one of predetermined styles by the user.

7. The method of claim 1, wherein the generating of the 3D character comprises generating the 3D character by using only an image which satisfies a predetermined image quality reference among the received images.

8. The method of claim 1, wherein the executing of the game comprises replacing a current character with the generated 3D character.

9. The method of claim 1, wherein the executing of the game comprises providing a menu to add the generated 3D character to a current character and selecting the generated 3D character by the user.

10. A server for providing a three-dimensional (3D) character on a game to a client in a cloud computing environment, the server comprising:
a receiver configured to receive from the client images designated by a user;
a generator configured to generate the 3D character by using the received images; and
an executor configured to execute a game in which the generated 3D character appears, by interworking with the client.

11. The server of claim 10, wherein the generator is configured to generate a new 3D character by only modifying a portion of a body of a 3D character that is provided in the game.

12. The server of claim 10, further comprising an attributing unit configured to provide the generated 3D character with a new attribute based on an external feature of the generated 3D character.

13. The server of claim 10, wherein the generator is configured to provide a menu to edit an external shape of the 3D character according to a user selection.

14. The server of claim 13, wherein the menu for editing the external shape of the 3D character comprises a menu for editing a color or size of a portion or all of a body or costume of the 3D character.

15. The server of claim 10, wherein the generator is configured to provide a menu for selecting one of predetermined styles by the user.

16. The server of claim 10, wherein the generator is configured to generate the 3D character by only using an image which satisfies a predetermined reference image quality from among the received images.

17. The server of claim 10, wherein the executor is configured to replace a current character with the generated 3D character.

18. The server of claim 10, wherein the executor is configured to provide a menu to add the generated 3D character to a current character and selecting the generated 3D character by the user.

19. A client for receiving a three-dimensional (3D) character on a game from a server in a cloud computing environment, the client comprising:
a user input configured to receive a user input to designate images;
a transmitter configured to transmit to the server the images designated by the user input; and
an executor configured to interworking with the server in order to execute a game in which the 3D character generated by the server appears, by.

20. A non-transitory computer-readable recording medium that stores a program, which, when executed by a processor of a computer, performs the method of claim 1.

21. A server configured to generate a three-dimensional (3D) character on a game, the server comprising:
a receiver configured to receive images designated by a user;
a generator configured to use the received images to generate the 3D character; and
an executor configured to execute a game in which the generated 3D character appears.

22. The server of claim 21, further comprising an attributing unit configured to provide the generated 3D character with a new attribute based on an external feature of the generated 3D character.

23. The server of claim 21, wherein the images designated by the user are received from a client.

24. The server of claim 21, wherein the generator is configured to provide a menu to edit an external shape of the 3D character according to a user selection.

25. The server of claim 21, wherein the executor is configured to replace a current character with the generated 3D character.
